(19) United States
(12) Patent Application Publication
(10) Pub. No.: US 2001/0027429 A1
(43) Pub. Date: Oct. 4, 2001

(54) System and method for ordering component parts for equipment

(76) Inventor: Takeshi Uemura, Minami-ku (JP)

Correspondence Address: PRICE, GESS & UBELL, 2100 S.E. Main St., Ste. 250, Irvine, CA, 92614, US

(21) Appl. No.: 09/768,091

(22) Filed: Jan. 23, 2001

(30) Foreign Application Priority Data
Feb. 1, 2000 (JP) 2000-24059

(51) Int. Cl. G06F 17/60

(52) U.S. Cl. 705/27; 705/26; 705/29

(57) ABSTRACT

An apparatus, system, and method facilitating the ordering of supplies and replacement component parts between a supplier and a user is provided. The operating equipment includes a data processor for not only controlling the operation of the equipment but also to implement an ordering system for replacement parts by establishing a communication link with the supplier's data processing apparatus. The operating equipment can also contain data to maintain an inventory of repair parts and to facilitate identifying a desired repair part by displaying an exploded dissembled view of the component parts that make up the operating equipment on a display screen. Appropriate user identification numbers and passwords can prevent unauthorized ordering of parts.

### BACKGROUND OF THE INVENTION

1. Field of the Invention

The present invention relates to a system and a method for ordering parts that are used in equipment, such as an analyzer apparatus of an analyzing system, and more particularly to equipment that can support a direct monitoring and maintenance of its own components parts between the user and the manufacturer of the equipment.

2. Background of the Invention

In recent years, analyzer apparatus in most analyzing systems include a data processor and the management of such equipment, such as remote maintenance of the analyzing system, can be performed by utilizing the data processor.

The present applicant proposed a system that displays a table and/or a diagram containing analysis data, inspection results, a log of use, and a stock of parts including expendable supplies and equipment, in a time series, according to Japanese Patent Application No. 9273941 (entitled as “Equipment Managing System in Analyzing System”), filed on Sep. 18, 1997.

When the managing system of this application is employed, a user of the analyzing system can ascertain the stock of parts including expandable supplies and equipment at any time. When the stock level reaches a predetermined number of parts suitably selected by the user, the user contacts with shops or dealers, of the analyzing system, decides a name, a manufacturer, quantity of the part, and makes an order for the part to its dealer. Generally, the dealer also decides a name, quantity and so forth of the part, and makes an order for the part to the manufacturer of the analyzing system, thereby creating a goods distribution channel for the part. Finally, the manufacturer accepts an order for the part from a direct dealer, or distributor, which is located directly under the manufacturer in the distribution channel. The manufacturer of the analyzing system delivers the part to the direct distributor, and the part is delivered to the user through the goods distribution channel.

However, in the managing system above described, since ordering of the parts is performed by way of a goods distribution channel, a number of days have been generally required from the actual time of placing an order until receiving the ordered part by the user. Also an extra charge is added by the handling of an immediate dealer in the goods distribution channel, thereby increasing a cost of the ordered part which cannot be avoided.

Further, the intermediate dealer often procures the part from another goods distribution channel other than a proper goods distribution channel, based on the intermediate dealer's own judgment and profit incentive. Thereby, a part, which is not genuine, may be assembled into the analyzing system, and it sometimes may cause trouble with the analyzing system. As a result, it is often required for resolving the trouble, which would not have occurred if the genuine part had been originally used, that the manufacturer of the analyzing system must dispatch a technical expert and the technical expert spends time and effort to repair and to perform maintenance. Therefore, this causes a loss for both the user and the manufacturer.

Further, on the user's side, since a considerable time duration is required to receive the ordered parts, the user's inventory stock of parts must be increased and either a depository must be secure or inventory management must be added to the cost.

Particularly, in the case of an analyzing system, an analyzer apparatus which is customized to a special specification depending on the demands of the user, is often manufactured, and thereby the number of variations of each part, including expendable supplies and equipment are increased. For example, there are parts which each require special performance, such as heat resistance, pressure resistance and corrosion resistance, even if those parts have a similar outward appearances. Consequently, it is difficult to order the parts corresponding to an analyzing system owned by the user without a mistake and a delivered part ordered with an incorrect part number will not conform to the analyzing system owned by the user.

An object of the present invention is to provide a system and a method for improving the ordering of parts for an analyzing system and for supplying parts including expendable supplies and equipment required for operating the analyzer apparatus, to a user in a reliable and rapid manner, and moreover at a low cost.

### SUMMARY OF THE INVENTION

To solve the above objects, a system for ordering parts of an analyzing system according to a first aspect of the present invention includes a system for ordering parts for an analyzing system employing an analyzer apparatus having a data processing apparatus characterized in that the data processing apparatus comprises a storage medium for storing at least a part number as part data of the analyzing system and a communication unit capable of ordering a part corresponding to a part number by transmitting the part number to a remote data processing apparatus of a supplier of the analyzing system.

A second aspect of the present invention is a system for ordering parts for analyzing systems owned by a plurality of users, respectively, consisting of analyzer apparatuses, each having a data processing apparatus characterized in that the data processing apparatus of each analyzing system comprises a storage medium for storing a user identification number and at least a part number as part data of the analyzing system and a communication unit capable of transmitting as part of an order the user identification number and the part number to a data processing apparatus on a supplier's side. The supplier's data processing apparatus is capable of accepting an order from the user by receiving the user identification number and a part number from the communication unit and determining it is an authorized order.

According to a system for ordering parts for an analyzing system, the user can perform an ordering of a part only be reading out a part number from the part data stored in storage and by transmitting the part number with the communication unit of the data processing apparatus in the analyzing system, whereby the ordering process can be performed rapidly. Since the order is accepted by the remote data processing apparatus on the supplier's side, the supplier of the analyzing system can dispatch immediately the part corresponding to the order. Consequently, the time duration from placing the order until receiving the goods is remarkably reduced.

Therefore, since the user can procure each of the parts rapidly, the user is not required to stock a large number of parts including expendable supplies and equipment. Since an intermediate goods distribution channel can be omitted, the goods distributing channel is simplified, and the ordered part can be procured at a low price, and therefore the management costs of the analyzing system can be reduced. Moreover, the ordered part is rapidly delivered, and thereby any stopping and suspending of the analyzing system caused by a lack of the part can be prevented even if an unexpected situation has occurred. In the case of an analyzing system used for controlling the management of a factory production line, an occurrence of an unexpected situation, such as a stop of factory production, can be prevented.

Furthermore, generic replacement parts can be avoided, since there is no possible decision by an intermediate dealer to use general purpose parts instead of the genuine parts, thus a possible cause of trouble for the analyzing system can be reduced. A part number as parts data is stored on the storage medium of the data processing apparatus and genuine parts with special properties according to the types and the specifications of the analyzing system owned by the user can be placed and accepted as orders, and thus trouble can be avoided.

A variety of forms of communication units can be used. For example, the communication unit may include a communication modem which is connected to the user's data processing apparatus and the supplier's data processing apparatus, respectively, over a private phone line. A general public line or a portable telephone line may be substituted for the private line, and also the Internet™ may be used to connect between the data processing apparatuses. Further, the parts need not be limited to tangible objects, such as expendable supplies or equipment, but could also include computer application programs, such as analyzing methods for using the analyzing system, or data and analysis methods for use to provide an analyzed result.

The user's data processing apparatus may further include stored image data of a parts diagram for clarifying an installing position of each part and a shape of each part in a disassembled condition or exploded view of the analyzer apparatus and may have a function for obtaining a part number by a user designating a specific component on the parts diagram with an input device. In this case, the user can disassemble the analyzer apparatus according to a predetermined procedure with reference to the parts diagram displayed as a three-dimensional specifying diagram and can designate a damaged part or worn part from the parts diagram, and thereby the user can obtain the part number of the damaged part or worn part and thus can reduce any mistakes.

If the analyzing system owned by the user is customized with an unusual specification, it may be difficult to specify the part number of each component part of the analyzer apparatus even by an engineer employed by a manufacturer. Therefore, the function of obtaining each part number according to the displayed specification of the analyzing system and permitting the user to designate on the parts diagram can contribute to a reduction of mistakes in ordering parts. Whether the data processing apparatus on the user's side automatically orders a corresponding part of a user or performs the ordering process using the parts number after obtaining the parts number, can be optionally determined according to the desire of the user.

The user's data processing apparatus may include the number of the components in the stock inventory for each part as a portion of the part data stored in the storage medium and may automatically create an order for a part when the number of inventory stock parts falls below a predetermined number. In this case, the user does not need to actively manage specially the inventory stock of parts, therefore a burden on the user in managing the analyzing system can be eased. Even in this case, whether the user's data processing apparatus automatically orders a corresponding part or not is a matter optionally selectable by the user.

The user's data processing apparatus may also have a function of updating the parts data by way of transmitting and receiving the parts data stored in the storage medium in response to an instruction from the supplier's data processing apparatus. In this case, if a part having a part number stored in the user's data processing apparatus has been discontinued by a part maker, the part number can be updated with a new part number of another part compatible with the outdated part.

Consequently, since an analyzing system is frequently used for extended time periods, the part maker sometimes discontinues lines of parts. In such a case, the part number can be updated to the part number of another part compatible with the discontinued part which is provided by the manufacturer of the analyzing system, and thereby the rapidly placing and accepting of an order of the new parts can be maintained.

A method for ordering parts of an analyzing system according to a third aspect of the present invention permits the ordering of parts of an analyzing system by storing at least a part number as machine-readable part data in a data processing apparatus provided in an analyzing system, and transmitting the part number for the part from a data processing apparatus on the user's side of the analyzing system to a remote data processing apparatus on a supplier's side of the analyzing system, thereby ordering the part corresponding to the part number.

A method for ordering parts of an analyzing system according to a fourth aspect of the present invention includes ordering parts of an analyzing system by storing a user identification number at least a part number as part data of the analyzing system owned by a user in each of the data processing apparatuses provided in analyzing systems owned by a plurality of users, respectively, and receiving the user identification number and the part number from the data processing apparatus of each analyzing system at the data processing apparatus of the supplier's side of the analyzing system, thereby accepting an order of the part corresponding to the part number from the user corresponding to the user identification number.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a diagram showing a schematic view of a system for ordering a component part of an analyzing system according to the present invention.

FIG. 2 is a diagram for illustrating a storage portion of the system for ordering parts for the analyzing system;

FIG. 3 is a diagram for illustrating another part of the system for ordering parts for the analyzing system;

FIG. 4 is a diagram showing an example of parts data stored in the analyzing system; and

FIG. 5 is a diagram showing another example of the parts data stored as image data and displayed in the analyzing system.

### DETAILED DESCRIPTION OF THE PREFERRED EMBODIMENT

The following description is provided to enable any person skilled in the art to make and user the invention and sets forth the best modes contemplated by the inventor of carrying out his invention. Various modifications, however, will remain readily apparent to those skilled in the art, since the general principles of the present invention have been defined herein specifically to provide a system and method that can be installed in the equipment for enabling the ordering of component parts for equipment during its time service.

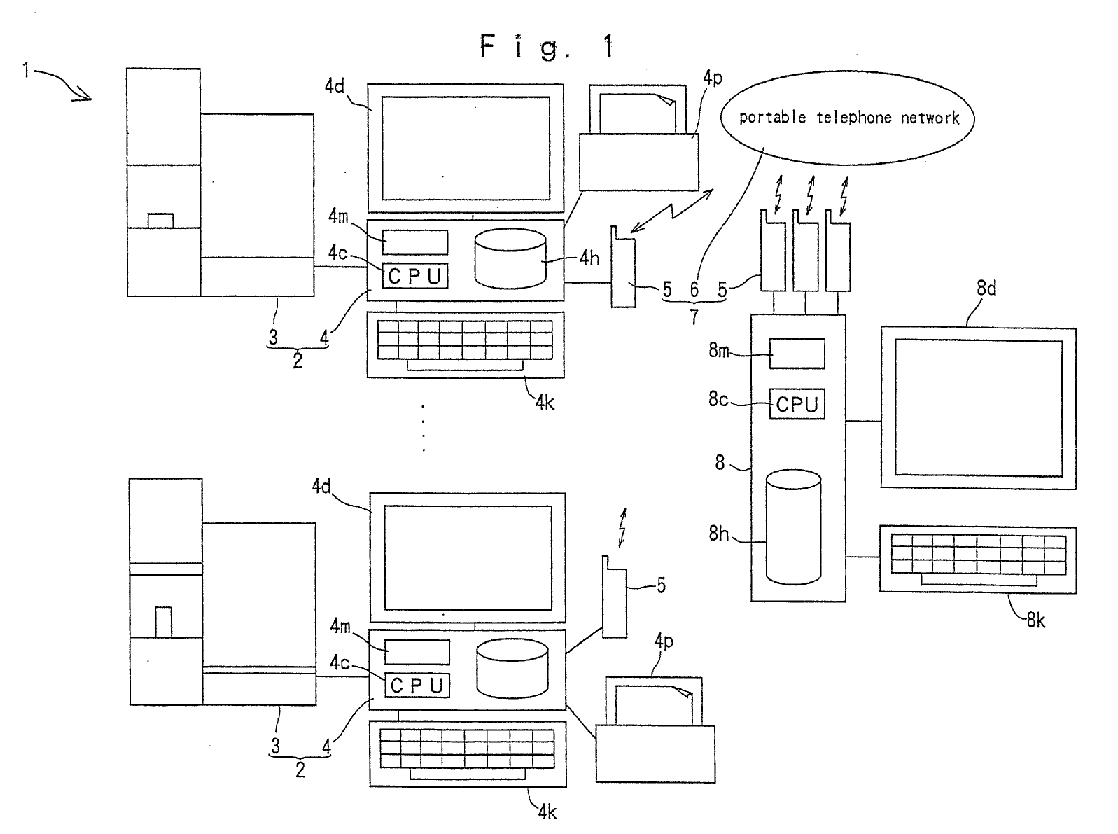

FIG. 1 is a diagram showing schematically a parts ordering system 1 for an operating analyzing system according to an embodiment of the present invention. Referring to FIG. 1, a pair of analyzing systems 2 each comprise analyzer apparatuses 3 (the analyzer apparatuses 3 may have different structures, respectively, but are denoted with a common reference numeral for simplifying the explanation) and data processing apparatuses which may include personal computers (hereinafter referred to as personal computers) 4. The analyzer apparatuses 3 perform an analysis of metals, have a detector (not shown), introduce a combustion gas caused by burning metals in an electric furnace into a measuring cell, and output a measured value detected by an infrared detector to the respective personal computer 4. These functions are known and used in commercial analyzing systems and accordingly are nor described in detail herein.

The personal computer 4 generally has a storage section or medium 4h such as a hard disk drive as well as a CPU (central processing unit) 4c and a memory 4m, and is connected with an input operation section 4k such as a keyboard and mouse controller, a monitor display section 4d, a printer 4p and so forth by way of conventional interface circuits (not shown). The storage section 4h is not limited to a hard disk drive, but may also comprise a magneto optical disk device, a non-volatile memory device, a server connected by a LAN (local area network), or the like.

A reference numeral 5 denotes an example of a modem installed in a personal computer 4 and includes a connection to a conventional portable telephone, such as a personal hand phone system. A reference numeral 6 denotes a portable telephone network for the portable telephone 5. The portable telephone 5 and the portable telephone network 6 form a portion of a communication unit 7 according to the present invention. A stored communication program can activate a data link through the communication unit 7 by dialing up a phone number at a remote site. A reference numeral 8 denotes the data processing apparatus of the supplier's side of the analyzing system 2, connected with the communication unit 7, which can execute the communication program. The data processing apparatus 8 comprises a storage section 8h, such as a hard disk drive, an input operation section 8k, such as a keyboard, and a monitor display section 8d, as well as a CPU 8c, and a memory section 8m.

If the portable telephone 5 and the portable telephone network 6 are used in the communication unit 7, a communication line forming the communication unit 7 can be secured at a low cost. However, the present invention is not limited to such construction. For example, a modem, a terminal adapter, and a monitor, as well as a general portable telephone for connecting with a general telephone line can be used instead of the conventional portable telephone 5.

Consequently, the general telephone line, the private line or the like may be used instead of the portable telephone network 6. Additionally, communication between the personal computer 4 and the data processing apparatus 8 can be achieved with communication through an Internet link.

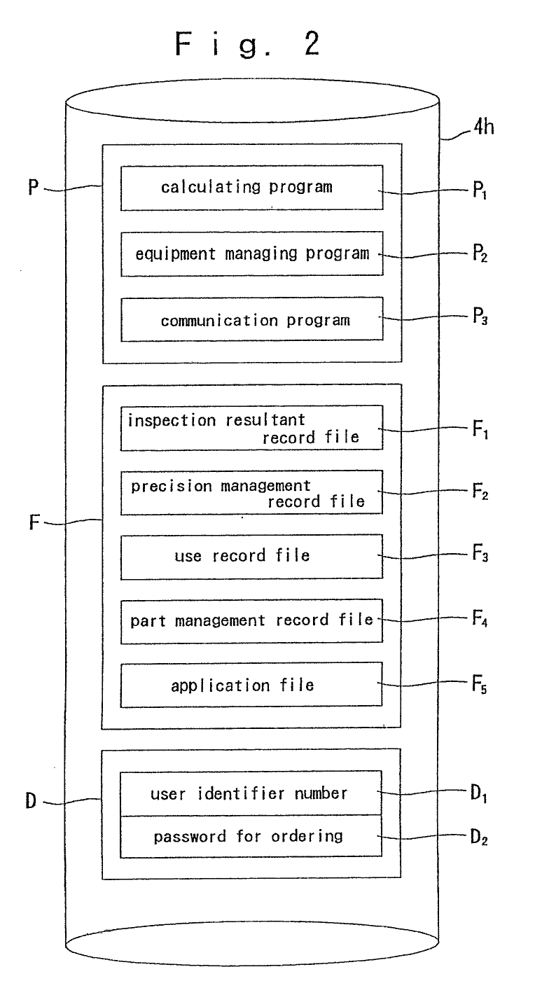

FIG. 2 is a schematic diagram disclosing data contents stored in the storage medium or section 4h. As shown in FIG. 2, the storage section 4h stores an operating calculating computer program P₁ for calculating an analyzed measured value by the personal computer 4, an equipment managing program P₂, and a communication program P₃ for communication with the data processing apparatus 8, as examples of programs P that can be processed by the personal computer 4. The storage section 4h stores data D, such as a particular user identifier number D₁ for identifying the user of the analyzing system and a password D₂ required for placing any orders, in addition to an inspection resultant record file F₁, a precision management record file F₂, a use record file F₃, a part management record file F₄ (this file can also store image data for display of components on a monitor), and an application file F₅, such as data and method for indicating a particular analyzing method (e.g., heating pattern in case of a metal analyzer) by the analyzer apparatus 3, as a record file F.

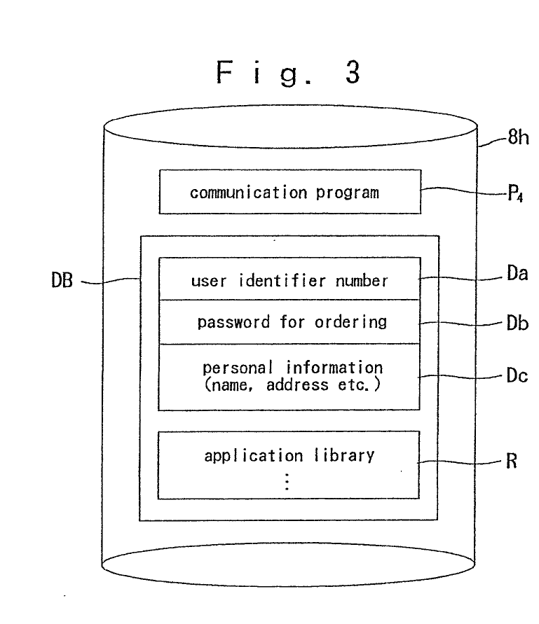

FIG. 3 is a diagram disclosing the contents stored in the storage section 8h of the data processing apparatus 8 on the supplier's side of the analyzing system. As shown in FIG. 3, the storage section 8h stores a communication program P₄ which can be processed by the data processing apparatus 8. In addition, the storage section 8h stores a user identification number Da for each analyzing system 2, a password Db for ordering, and personal information Dc with reference to an address of the user, a method for payment, and the like, as a database DB, and the data Da, Db, and Dc in the data base DB are associated with each other. Further, the storage section 8h stores an application library R which can contain both data and various methods for indicating an analyzing method or procedure to be implemented by the analyzer apparatus 3.

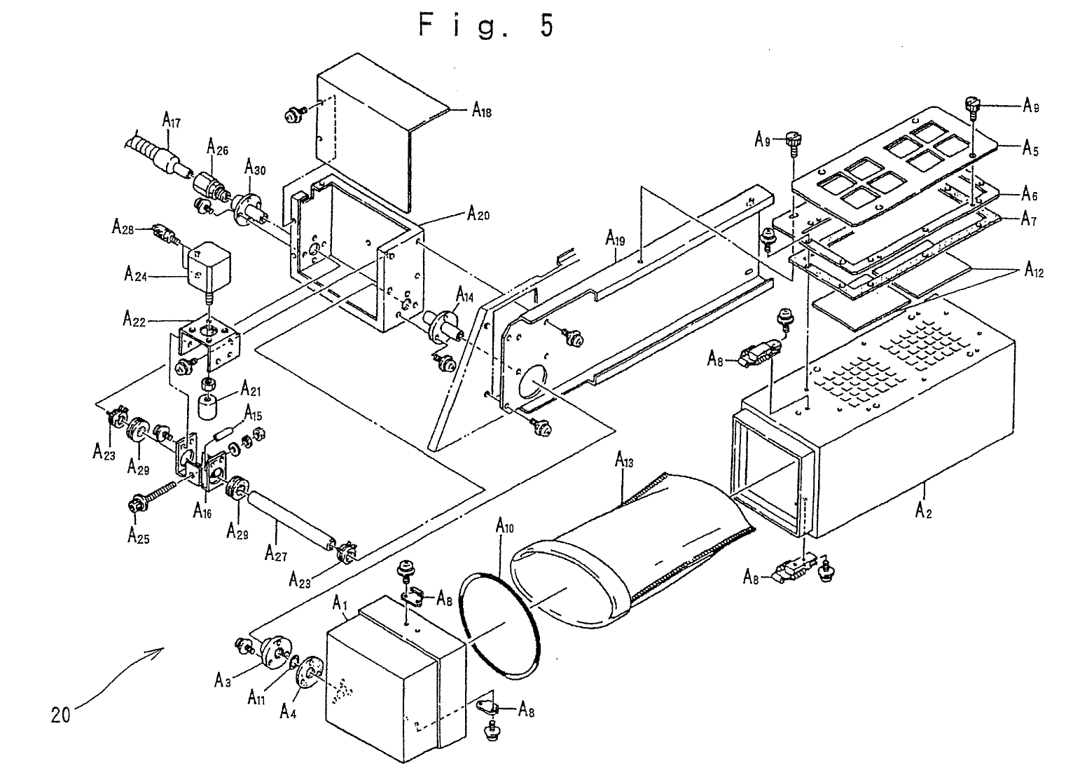

In the construction described above, the personal computer 4 shown in FIG. 1 reads the equipment managing program P₂ stored in the storage section 4h into the memory 4m and initiates it, and thereafter reads the record files F₁-F₅ from the storage section 4h and displays a record screen or window on the display section 4d. For example, a screen can be displayed and the user can exercise various options, such as filing in an order request, displaying an exploded view of the components as shown in FIG. 5 to assist in maintenance and in identifying a specific component part to be replaced, monitoring inventory and reviewing a history of replacement parts for the equipment, including setting a level of inventory parts to initiate an order routine. The printer 4p is controlled by the CPU 4c so as to be able to print the record screen displayed on the display section 4d.

Next, the displayed contents of the display section 4d using the part managing record file F₄ of the record files F will be described.

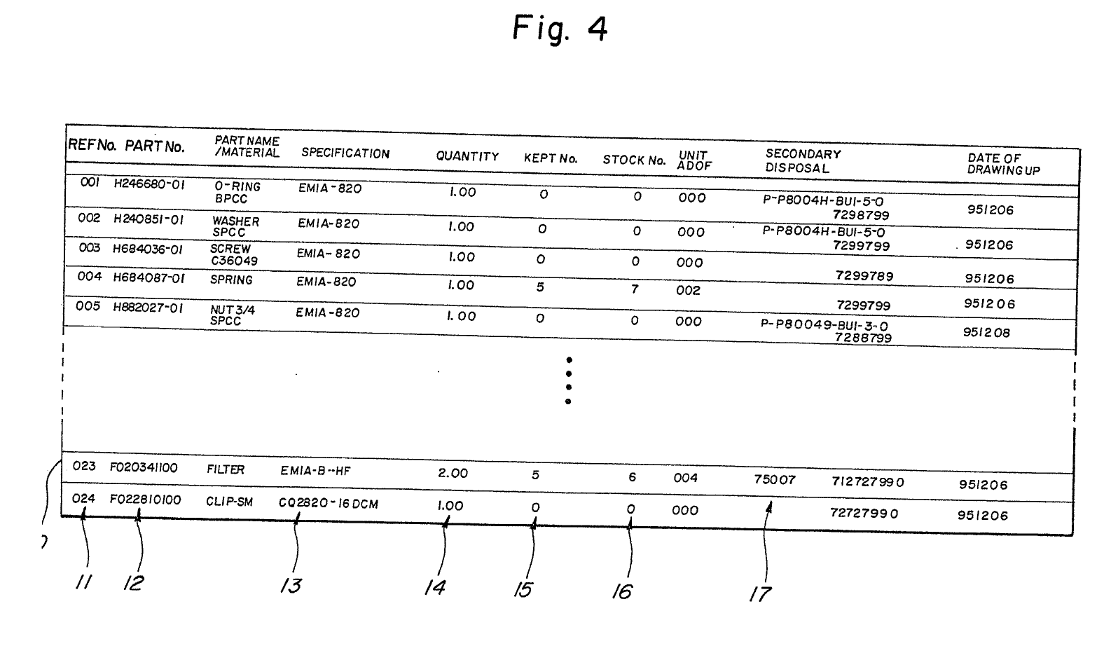

FIG. 4 is a diagram showing a part use managing screen and a part managing record table 10 which is developed with user input entries to the part managing record file F₄. In the part managing record table 10, a reference number 11, a part number 12, a part name A₁-A₂₄, an additional information 13, such as material and a specification, a using quantity 14, a number of parts to be kept 15, the number of parts in stock 16, a unit number of an order 17, and so forth, of each component part for reconstructing the analyzer apparatus 3 are indicated. Various menus can be displayed to the user to permit entry of data to update the record table 10.

Hereinafter, a part of the configuration of analyzer apparatus 3 is described. FIG. 5 shows an exploded view of the respective component parts in the analyzer equipment to enable a specifying diagram 20 corresponding to the part managing record table 10, and parts diagram A₁-A₃₀ (for convenience, the same reference numeral as the part name of FIG. 4 is used) are depicted three-dimensionally and displayed so as to clarify a fixed position and a shape of each part in a dismantled condition of the analyzer apparatus 3. This specifying diagram 20 can be displayed by switching a screen while displaying the part managing record table 10, for example. Consequently, the user of the analyzing system 2 can actually dismantle the analyzer apparatus 3 by referring to the specifying diagram 20 and can easily find a part diagram of a damaged component part, including expendable supply equipment.

Then, by designating on the screen the particular component on the part diagram corresponding to the damaged part within the specifying diagram 20 with a pointing device, such as a mouse or a keyboard 4k, a correct part number can be obtained. This obtaining of the part number can be displayed also on FIG. 4 by inverting or flickering of the characters on a corresponding line in the part managing record table 10.

Assuming as an example, an O-ring A₁₁ in the specifying diagram 20 has been degraded and a leak is occurring in the analyzer apparatus 3. In this case, the user can display the specifying diagram 20 of FIG. 5 on the display section 4d of the personal computer 4 to be instructed on a removal of a dust box A₁ and a seal block A₃ by referring to the display diagram, and Xn pick out the particular O-ring A₁₁ which is damaged. Thus, by designating the part diagram A₁₁ corresponding to the O-ring from the specifying diagram 20, the part managing record table 10 is subsequently displayed on the display section 4d, and the user can confirm the part number 12, the using quantity 14, the number to be kept 15, the number of inventory stock 16, and the unit number of an order 17.

Thereby the correct O-ring A₁₁ can be picked out within a large number of kinds of parts that are stocked without mistake at a predetermined position corresponding to the specifying diagram 20.

Next, the user decreases the number of the stock items 16 in the part managing record table 10 by the number used, and if the number of the stock 16 becomes less than a predetermined number 15 to be kept in inventory, the personal computer 4 can output a warning message which urges the ordering of the O-ring A₁₁. The user can instigate an ordering of the part by a one-touch operation by only pressing an order button or by some other key input operation related to a button on the display screen, for example. When the user instructs ordering the part, preferably, the order can only come from a specific part stock manager, by requesting an input of the password d₂ on ordering and the order can be effective only when the inputted password coincides with the password previously recorded on the storage section 4h, shown in FIG. 2.

When an order is requested by the user, the personal computer 4 reads out the part number 12 and the unit number of order 17 from the part managing record table 10, attaches the user identification number D and the ordering password D₂ and creates a transmission order data to the data processing apparatus 8 of the supplier's side based on the corresponding number of parts of the part number 12 and the unit number of the order 17. Then, the personal computer 4 initiates the communication program P₃ and transmits the transmission data to the remote data processing apparatus 8 on the supplier's side by way of the communication unit 7.

The data processing apparatus 8 collates, the user identification number D₁ and the ordering password D₂ received by the communication program P₄ with a stored user identification number Da and the ordering password Db, respectively, and thereby only when these coincide with each other will the data processing apparatus 8 accept the order from the user's side. Thus, the user's name, ordered date and ordered time can be recorded in a log by reading out detailed information, such as a shipping address for the ordered part from the personal information of the user Dc using the database DB. Then, the data processing apparatus 8 performs the dispatch procedure for invoicing and dispatching directly to the user the parts of the received part number 12 by the number corresponding to the unit number of orders 17.

The dispatch procedure of the parts may be performed automatically so that the data processing apparatus prints automatically the invoice, the statement of delivery and the like using the printer connected with the data processing apparatus 8 when the data processing apparatus 8 accepts an order by receiving the transmitted data from the user's side. Preferably, the dispatch procedure can be performed under supervision of a person in charge of accepting the order. Further, a confirmation of the telephone number of the caller may be added as a condition of accepting the order in consideration of additional security.

The part making record table 10 can be displayed in a time series which is not shown in FIG. 4 so that a history of the fluctuation of the number of items in stock for each part can be confirmed. That is, by displaying the fluctuation of the number of stock in a time series, the frequency of part ordering can be monitored, and thereby the unit number of orders 17 can be adjusted suitable to prevent the inventory stock from being deleted and to manage an effective use of storage space for stock components.

According to the present invention, since a third party goods distribution channel has been eliminated, not only the time required for delivery of the parts is shortened and rapid repairs can be achieved, but also the parts can be supplied at a lower cost because of removal of an intermediate charge on the price of the goods. Additionally, the number of inventory items on the user's side can be reduced and the management of the stock can be made easier.

The part managing record table 10 for indicating the parts number and the number of stock item and the specifying diagram 20 consisting of the part diagram which clarifies the fixed position and the shape of the part as the part data of each of the parts in the storage section 4h of the personal computer 4 is provided in the analyzer apparatus 3 delivered at purchase to the user. Therefore, ordering of a part corresponding to the analyzer apparatus 3 owned by the user, even if the analyzer apparatus 3 is designed for a specialized specification or is customized partially can be accomplished with ease.

In the above description, an example of ordering that can be performed by the user is disclosed, but the present invention is not limited to this procedure. For example, upon receiving a request from the user's side, a serviceman on the manufacturer's side can browse the apparatus history F₁-F₄ (see FIG. 2) recorded on the analyzing system 2 of the user's side in time series, through a link with the communication unit 7 from the data processing apparatus 8 of the manufacturer's side, and can perform suitable maintenance by deciding the condition of the analyzing system 2. In this situation, the serviceman on the manufacturer's side can point out those parts which are insufficient and then an order can be accepted by receiving the parts number.

It is preferable that the contents of the part management record file F₄ of the part data recorded on the storage section 4h is transmitted and received in response to an instruction from the remote data processing apparatus 8 on the supplier's side, and thus the part data can be updated. In this case, the supplier of the analyzing system can update the part number 12 to the newest data, if the part number of the original part is discontinued by the manufacturer and replaced with another part number compatible with the part of the old part number. The manufacturer of the analyzing system can most suitably decide the compatibility of the part, and thus trouble can be minimized. In case the analyzing system 2 has a long period of durability, especially during a period of using the analyzing system 2, the part used in the system 2 may be discontinued, in such a case this function is important.

The data processing apparatus 8 on the supplier's side stores a conversion table for converting the part number of the old part to the part number of the compatible part, thereby an order of a part accepted in the old part number is replaced with a part with a new part number, and the part corresponding to the new part number can be dispatched.

In the embodiment described above, an example of ordering a tangible component part as a part is disclosed, but the present invention is not so limited. Therefore, in case of a metal analyzer apparatus 3, the personal computer 4 on the user's side may order a special program application, such as a particular heating pattern for extracting a specific component in the metal, and enabling data for permitting an analysis of a gas generated by the combustion burning, to the data processing apparatus 8 of the manufacturer's side. In the case where the analyzer apparatus 3 is a gas analyzer, an absorption property for a wavelength of a specific material can be part of the application.

In this case, the data processing apparatus 8 which accepts an order sends a designated application in the application library R stored in the storage section 8h of the data processing apparatus 8 to the user as an application file, thereby such a part can be dispatched. On the other hand, at the user's side the received application file is kept in the storage section 4h and suitably provided for use. The manufacturer of each of the analyzing systems 2 produces application files capable of analyzing a variety of material by using one program after another at any time. The user can always analyze in the best environment by virtue of registering the application files onto the application library.

In the above described embodiment, an example of forming the analyzing system 2 by combining the analyzer apparatus 3 and an appended data processing apparatus 4 is individually provided, however, the present invention is not so limited. That is, the present invention can also apply to an analyzing system which unified the date processing apparatus within the analyzer apparatus, per se.

Since the user can order a required part only by retrieving the part number among the part data stored in the storage section in accordance with the analyzing system owned and sends the part number by way of the communication unit of the data processing apparatus of the analyzing system, the process for placing the order can be performed rapidly. Since the order is accepted by the data processing apparatus on the supplier's side, the supplier of the analyzing system can dispatch directly the ordered part to the user. Consequently, the time duration between ordering and the receiving of the goods is substantially shortened.

Further, since the user can procure parts rapidly, the stored quantity of the parts, including expendable supplies and equipment, can be reduced and thus stocking and managing of the parts becomes easier. Since an intermediate goods distribution channel is omitted, the goods distribution is simplified, thus the ordered parts can be procured at a low cost, and the managing cost of the analyzing system can be reduced. Additionally, since the rapid delivery of goods can be achieved, stopping of the analyzing system caused by lack of parts can be prevented, even if an unexpected situation occurs. In case an analyzing system is utilized for managing a factory production line especially, an occurrence of an unforeseen accident, such as a stopping of factory production, can be avoided.

In addition, since generic parts can be avoided, genuine parts are utilized for saving cost and time. Since the part numbers as part data are stored in the storage section of the data processing apparatus on the user's side, a genuine part having a characteristic corresponding to a type and a specification of the analyzing system owned by the user can be ordered and problems can be avoided.

When the data processing apparatus on the user's side includes a parts diagram which can be displayed for clarifying the installing position of each part and the shape of each part in a disassembled condition of the analyzer apparatus, the user can disassemble the analyzer apparatus and designate a damaged part or worn part from the parts diagram in the specifying diagram, and thereby the user can obtain the part number of the damaged part or worn part. If the analyzing system owned by the user is customized with an unusual specification, the function for obtaining each part number according to the specification of the analyzing system by designation on the parts diagram can reduce remarkably the occurrences of mistakes in ordering parts.

In case the data processing apparatus on the user's side has a number of inventory stock for each part as the part data stored in the storage member and automatically orders parts when the number of the stock item becomes less than a predetermined number, a user does not need to manage specifically the stocking of the parts, therefore a burden on the user in managing the analyzing system can be eased.

When the data processing apparatus on the user's side has a function to update the parts data by way of transmitting and receiving the parts data stored in the storage member in response to an instruction from the data processing apparatus on the supplier's side, even if a part having a part number stored in the data processing apparatus on the user's side has been discontinued by a part maker, the part number can be updated with a new part number of another part compatible with the outdated part correctly, and a safe genuine part can be supplied.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. In an apparatus having a data processor system for controlling an operation of the apparatus, the improvement comprising:
a storage member for storing, as machine-readable data, identification part numbers for a plurality of components used in the apparatus, and
a communication unit for ordering a replacement component corresponding to a stored identification part number by transmitting the identification part number as part of an order request to a remote receiver.

2. The invention of claim 1 further including a display screen, image data that can be displayed as images of the plurality of components on the display screen stored in the storage member, and an operator input device for designating a specific displayed component image as a replacement component that can be ordered through the communication unit.

3. The invention of claim 2, wherein the image date represents an exploded view of the components arranged in an ordered relationship to a disassembled view of the apparatus.

4. The invention of claim 1, wherein the storage member also stores inventory data representative of the number of components maintained in inventory at the site of the apparatus and the communication unit has a receiver for being polled from a remote location to monitor the inventory by transmitting, in response to an authorized request, the inventory data.

5. The invention of claim 1 further including an operating program for controlling the operations of the apparatus, the communication unit orders a replacement application program from a stored list of data representative of a library of operating programs.

6. The invention of claim 1 further including user identification data that is stored and transmitted by the communication unit.

7. A system for ordering parts for an analyzing system including an analyzer apparatus having a data processing apparatus, comprising:
a storage member operatively connected to the data processing apparatus for storing at least a part number as part data of the analyzing system owned by a user; and
a communication unit for ordering a part corresponding to a part number by transmitting the part number of the part to be replaced to a data processing apparatus of a supplier of the analyzing system.

8. A system for ordering parts for analyzing systems, owned by a plurality of users respectively, consisting of analyzer apparatuses, each having a data processing apparatus, the data processing apparatus of each analyzing system comprises:
a storage unir for storing a user identification number and at least a part number as part data of the analyzing system owned by a user; and
a communication unit capable of transmitting the user identification number and the part number of the part for which replacement is required to a remote data processing apparatus of a supplier, in which the remote data processing apparatus of the supplier accepts an order from the user by receiving the user identification number and a part number directly from the data processing apparatus of the user by way of the communication unit.

9. The system for ordering parts of analyzing systems as claimed in claim 8, wherein the user data processing apparatus includes image data of a parts diagram for clarifying an installing position of each part and a shape of each part in a disassembled condition of the analyzer apparatus as parts data stored in the storage member and means for obtaining a part number by permitting a user to designate a part on the parts diagram.

10. The system for ordering parts of analyzing systems according to claim 9, wherein the user data processing apparatus has the number of inventory items of stock of each part as part data stored in the storage member and automatically orders a part when the number of stock items is under a predetermined number.

11. The system for ordering parts of analyzing systems according to claim 10, wherein the user data processing apparatus updates the parts data by way of transmitting and receiving parts data stored in the storage member in response to an instruction from a supplier data processing apparatus.

12. A method for ordering parts for an analyzing system comprising:
storing at least a part number as part data in a data processing apparatus provided in an analyzing system; and
transmitting the part number of the part from a user data processing apparatus to a supplier data processing apparatus, thereby ordering the part corresponding to the part number.

13. A method for ordering parts of analyzing systems between a user of the analyzing system and a supplier of the analyzing system by comprising:
storing a user identification number and at least a part number as part data in the analyzing system owned by a user in each of the data processing apparatuses provided in analyzing systems owned by a plurality of users respectively; and
receiving the user identification number and the part number from the data processing apparatus of each analyzing system to a data processing apparatus of a supplier's side of the analyzing system; and
accepting the order of the part corresponding to the part number when the user corresponds to the user identification number.

14. The method for ordering parts of an analyzing system as claimed in claim 13, wherein the data processing apparatus of the user's side further displays a parts diagram for clarifying an installing position of each part and a shape of each part in a disassembled condition of the analyzer apparatus as the parts data on a display section and designating on the parts diagram on the display section a parts number linked to the parts diagram whereby the part is ordered.

15. The method for ordering parts of an analyzing system as claimed in claim 13, wherein the user data processing apparatus displays the number of parts in inventory stock for each part as the part data on the display section, and makes an order of the parts when the number of parts in inventory stock falls under a predetermined number.

16. The method for ordering parts of an analyzing system as claimed in claim 13, wherein the user data processing apparatus updates the status of the parts data by way of transmitting and receiving parts data, responsive to an instruction from the supplier's data processing apparatus.

17. A method of maintaining supplies and repair parts between a supplier and a user for an operating equipment having a data processing apparatus transferred from the supplier to the user, comprising:
loading the operating equipment with machine-readable data representative of each replaceable component that constitutes the operating equipment;
permitting the user to display the replaceable components with indicia representative of each replaceable component;
establishing a communication link between the operating equipment data processing apparatus and a corresponding supplier data processing apparatus;
designating the indicia of a replaceable component to be ordered by the user;
receiving the designated indicia at the supplier data processing apparatus over the communication link; and
delivering to the user the replaceable equipment.
